(19) United States
(12) Patent Application Publication
(10) Pub. No.: US 2024/0298844 A1
(43) Pub. Date: Sep. 12, 2024

(54) SHAKABLE MILK WARMER

(71) Applicant: Guangzhou Qingkuai Innovation Technology Co., Ltd., Guangzhou City (CN)

(72) Inventors: Yuanming XIAO, Guangzhou City (CN); Huihuang XIE, Guangzhou City (CN); Jialin ZHENG, Guangzhou City (CN); Qiuyan LIN, Guangzhou City (CN); Yonglun HUANG, Guangzhou City (CN)

(73) Assignee: Guangzhou Qingkuai Innovation Technology Co., Ltd., Guangzhou City (CN)

(21) Appl. No.: 18/455,270

(22) Filed: Aug. 24, 2023

(30) Foreign Application Priority Data
Mar. 6, 2023 (CN) 202320399636.2
Jul. 25, 2023 (CN) 202321971739.8

(51) Int. Cl. A47J 36/24

(52) U.S. Cl. CPC A47J 36/2438

(57) ABSTRACT

A shakable milk warmer includes a shell, a heating member, a rotating shaft, a connecting member, a cradle, a first quick-release portion and a second quick-release portion. The shell forms a water bath chamber with an open end, the heating member is in heat transfer connection with an outer wall surface of the water bath chamber. The rotating shaft is rotatably arranged to extend through a bottom portion of the water bath chamber. The connecting member is mounted at one end of the rotating shaft located in the water bath chamber. The first quick-release portion is a protrusion arranged on the connecting member, the second quick-release portion is a groove arranged in the cradle, the first quick-release portion and the second quick-release portion allow the cradle to be detachably mounted on the connecting member.

### CROSS-REFERENCE TO RELATED APPLICATIONS

This application is based on and claims the benefit of priority from Chinese Patent application Ser. No. 20/232,0399636.2, filed on Mar. 6, 2023 and Chinese Patent Application No. 202321971739.8, filed on Jul. 25, 2023, the entireties of these applications are incorporated by reference herein.

### TECHNICAL FIELD

The present disclosure relates to the field of milk warmers, and particularly to a shakable milk warmer.

### BACKGROUND

Milk warmers are used for heating brewed milk powder or frozen breast milk. Because babies are sensitive to temperature, it is required that the milk warmer can heat milk accurately and uniformly.

On one hand, in some existing milk warmers, a heating sheet is used to heat a milk bottle, and a heating surface cannot cover a whole outer surface of the milk bottle, which leads to non-uniform heating, thus affecting the accuracy of heating temperature of milk. If local temperature is too high, proteins may denature to form particles, leading to caking of milk powder, thus affecting the taste, and even leading to the loss of nutrients in the milk powder.

On the other hand, the milk bottle is usually placed in a cradle for heating, and the milk warmer may also drive the cradle to rotate or shake the milk bottle through a driving mechanism. The milk powder and the milk are easily left on a wall surface of the cradle. However, due to the connection of the driving mechanism, the heating sheet and the like with the cradle, the existing cradle is inconvenient to disassemble and wash, which leads to easy formation of dirt in the milk warmer, and the dirt is very likely to affect the health of babies.

### SUMMARY

The present disclosure aims to solve at least one of the technical problems in the existing technology. Therefore, the present disclosure provides a shakable milk warmer, and the shakable milk warmer can heat milk more uniformly, and facilitates disassembly and washing of a cradle.

In a first aspect of the present disclosure, a shakable milk warmer is provided, a water bath chamber with an open end is formed within the milk warmer, and the shakable milk warmer comprises: a heating member, wherein the heating member is in heat transfer connection with an outer wall surface of the water bath chamber; a rotating shaft, wherein the rotating shaft is rotatably arranged to extend through a bottom portion of the water bath chamber; a connecting member, wherein the connecting member is arranged at one end of the rotating shaft located in the water bath chamber, and the connecting member comprises a first quick-release portion; a cradle, wherein the cradle comprises: a clamping portion, the clamping portion comprises a plurality of elastic sheets arranged on an inner side wall of the cradle in a circumferential direction, and the elastic sheets are configured for abutting against an inner side wall of a milk bottle to clamp the milk bottle; and a second quick-release portion, wherein the second quick-release portion is arranged at a bottom portion of the cradle, the first quick-release portion cooperates with the second quick-release portion to allow the cradle to be detachably mounted on the connecting member, the cradle is configured for placing the milk bottle, the cradle comprises the clamping portion, and the clamping portion is configured for fixing the milk bottle, wherein the first quick-release portion and the second quick-release portion are cooperatively connected through a positioning column and a positioning hole to allow the cradle to be detachably connected to the connecting member.

In a second aspect of the present disclosure, a shakable milk warmer is provided, a water bath chamber with an open end is formed within the milk warmer, and the shakable milk warmer comprises: a heating member, wherein the heating member is in heat transfer connection with an outer wall surface of the water bath chamber; a rotating shaft, wherein the rotating shaft is rotatably arranged to extend through a bottom portion of the water bath chamber; a connecting member, wherein the connecting member is arranged at one end of the rotating shaft located in the water bath chamber; a cradle, wherein the cradle comprises: a clamping portion, the clamping portion comprises a plurality of elastic sheets arranged on an inner side wall of the cradle in a circumferential direction, and the elastic sheets are configured for abutting against an inner side wall of a milk bottle to clamp the milk bottle; a first quick-release portion, wherein the quick-release portion is a protrusion arranged on the connecting member; a second quick-release portion, wherein the second quick-release portion is a groove arranged in the cradle, and the cradle is detachably and limitedly mounted with the first quick-release portion through the groove; and a rotating member, wherein the rotating member is arranged between the water bath chamber and the connecting member, an outer ring of the rotating member is in interference fit with the connecting member, and an inner ring of the rotating member is in interference fit with an inner ring of the water bath chamber, so that the connecting member is rotatably connected to the water bath chamber. In addition, the rotating member is arranged between the water bath chamber and the connecting member, thus horizontally limiting the connecting member and improving stability of the connecting member during rotation.

### BRIEF DESCRIPTION OF THE DRAWINGS

The above and/or additional aspects and advantages of the present disclosure will become apparent and easy to understand from the descriptions of the embodiments with reference to the following drawings, wherein:

FIG. 1 is a cross-sectional view of a shakable milk warmer in First Embodiment of the present disclosure after a cradle is disassembled;

FIG. 2 is a cross-sectional view of the shakable milk warmer in First Embodiment of the present disclosure after the cradle is assembled;

FIG. 3 is an exploded view of a local structure of the shakable milk warmer in First Embodiment of the present disclosure;

FIG. 4 is a locally enlarged view of a region A in FIG. 1;

FIG. 5 is a schematic structural diagram of the shakable milk warmer in First Embodiment of the present disclosure;

FIG. 6 is a schematic diagram of assembly of a top cover and a shell of the shakable milk warmer in First Embodiment of the present disclosure;

FIG. 7 is a cross-sectional view of a shakable milk warmer in Second Embodiment of the present disclosure after a cradle is assembled;

FIG. 8 is an exploded view of a local structure of the shakable milk warmer in Second Embodiment of the present disclosure;

FIG. 9 is a locally enlarged view of a region B in FIG. 7;

FIG. 10 is a schematic structural diagram of a connecting member of the shakable milk warmer in Second Embodiment of the present disclosure; and

FIG. 11 is a schematic diagram of assembly of the cradle and the connecting member of the shakable milk warmer in Second Embodiment of the present disclosure.

Reference numerals:

10 refers to shell, 11 refers to first wall, 12 refers to second wall, 20 refers to heating member, 21 refers to mounting tray, 22 refers to heating tube, 30 refers to rotating shaft, 40 refers to connecting member, 41 refers to first quick-release portion, 50 refers to cradle, 51 refers to elastic sheet, 52 refers to handle, 53 refers to second quick-release portion, 60 refers to rolling body, 70 refers to first sealing member, 80 refers to second sealing member, 90 refers to first fixing member, 100 refers to temperature sensor, 110 refers to fuse, 120 refers to top cover, 130 refers to panel, 140 refers to protective sleeve, 150 refers to bottom cover, 160 refers to second fixing member, 170 refers to water tank, and 180 refers to rotating member.

### DETAILED DESCRIPTION

Various embodiments of the present disclosure will be described in detail hereinafter, and examples of various embodiments are shown in the drawings, wherein the same or similar reference numerals throughout the drawings denote the same or similar elements or elements having the same or similar functions. Various embodiments described hereinafter with reference to the drawings are exemplary and are only intended to explain the present disclosure, but should not be construed as limiting the present disclosure.

In the description of the present disclosure, it should be understood that the orientation or position relationships indicated by the terms such as “upper”, “lower”, “front”, “rear”, “left”, “right” and the like, refer to the orientation or position relationships shown in the drawings, which are only intended to facilitate describing the present disclosure and simplifying the description, and do not indicate or imply that the indicated devices or elements must have a specific orientation, be constructed and operated in a specific orientation, and therefore cannot be understood as a limitation of the present disclosure.

In the description of the present disclosure, the term “several” refers to being one or more, the term “multiple” refers to being two or more, and the terms such as “greater than”, “less than”, “more than” and the like are understood as not including the following number, while the terms such as “above”, “below”, “within” and the like are understood as including the following number. If there is the description of first and second, it is only for the purpose of distinguishing technical features, and should not be understood as indicating or implying relative importance, implicitly indicating the number of the indicated technical features or implicitly indicating the order of the indicated technical features.

In the description of the present disclosure, the terms “arrangement”, “installation”, “connection”, and the like should be understood in a broad sense unless otherwise specified and defined. The specific meaning of the above terms in the present disclosure may be reasonably determined according to specific contents of the technical solutions by those of ordinary skill in the art.

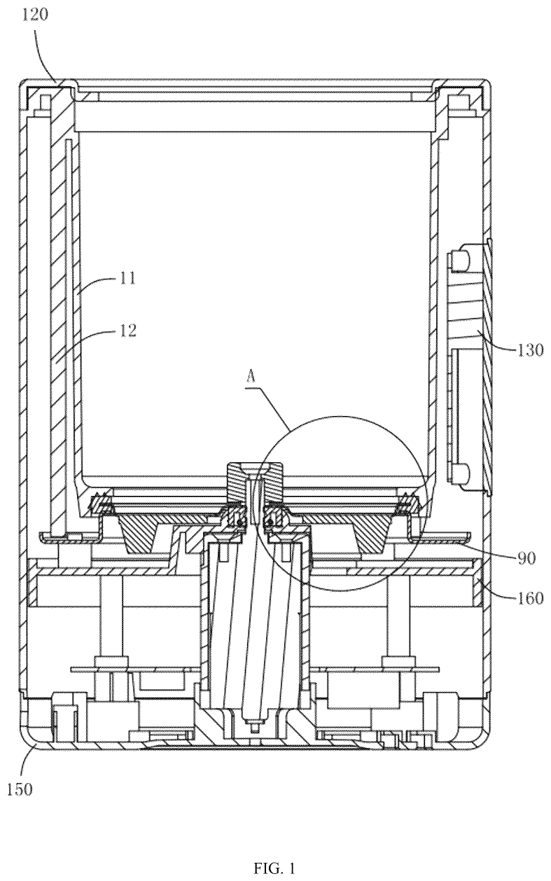

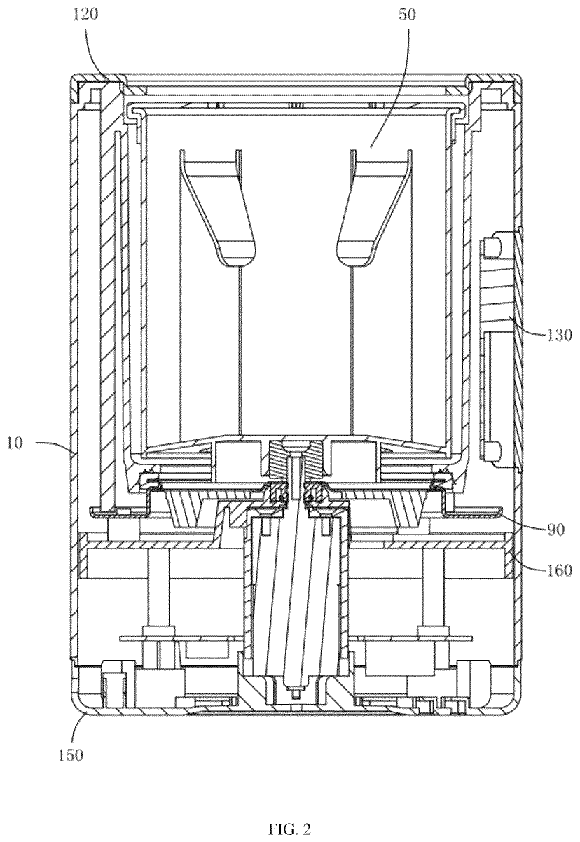

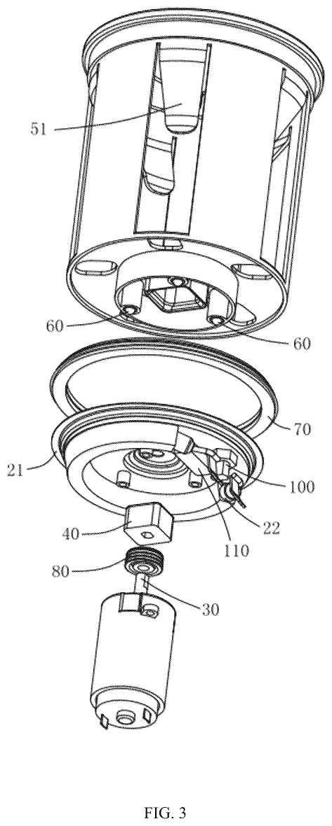

With reference to FIG. 1, FIG. 2 and FIG. 3, First Embodiment of the present disclosure provides a shakable milk warmer, a water bath chamber with an open end is formed in the shakable milk warmer, and the shakable milk warmer comprises a heating member 20, a rotating shaft 30, a connecting member 40 and a cradle 50. The heating member 20 is in heat transfer connection with an outer wall surface of the water bath chamber. The rotating shaft 30 is rotatably arranged to extend through a bottom portion of the water bath chamber. The connecting member 40 is mounted at one end of the rotating shaft 30 located in the water bath chamber, and the connecting member 40 comprises a first quick-release portion 41. The cradle 50 comprises a second quick-release portion 53. The second quick-release portion 53 is arranged at a bottom portion of the cradle 50, the first quick-release portion 41 cooperates with the second quick-release portion 53 to allow the cradle 50 to be detachably mounted on the connecting member, the cradle 50 is configured for placing a milk bottle, the cradle 50 comprises a clamping portion, and the clamping portion is configured for fixing the milk bottle.

According to the shakable milk warmer provided by the embodiment of the present disclosure, the milk bottle is positioned and placed in the cradle 50 through the clamping portion. The heating member 20 heats water in the water bath chamber, thus indirectly heating milk in the milk bottle, and the rotating shaft 30 drives the cradle 50 to rotate, which on one hand stirs the water in the water bath chamber to achieve uniform water temperature distribution, and on the other hand stirs the milk in the milk bottle to achieve uniform milk temperature distribution, thus heating the milk more uniformly.

Because water bath heating is used, the heating member 20 is separated from the cradle 50, and the cradle 50 is only connected with the rotating shaft 30, so that the cradle 50 can be easily disassembled and washed through the second quick-release portion 53, and dirt is not easy to accumulate.

It can be understood that the above-mentioned dirt may be residual milk powder and milk, or may be water scale formed during water bath heating. After disassembly, it is convenient to wash the cradle 50, and it is also convenient to wash a wall surface of the water bath chamber.

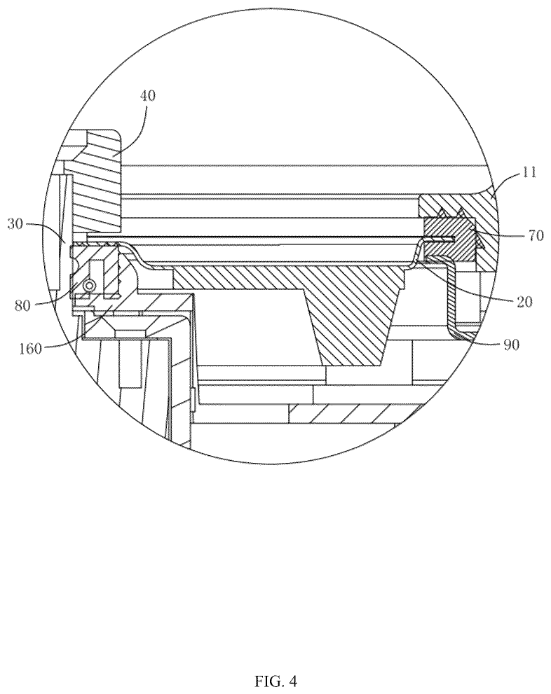

The shakable milk warmer drives the rotating shaft 30 to rotate through a driver. With reference to FIG. 3, in some embodiments, the driver is implemented by a rotating motor, and an output shaft of the driver directly serves as the rotating shaft 30. In other embodiments, the driver may also be in transmission connection with the rotating shaft 30 by belt transmission, gear transmission, and the like. With reference to FIG. 4, the connecting member 40 may be mounted on the rotating shaft 30 in a form of threaded connection through an abutment screw.

In some embodiments, the first quick-release portion 41 and the second quick-release portion 53 are cooperatively connected through a positioning column and a positioning hole, the positioning column and the positioning hole are correspondingly arranged in the first quick-release portion 41 and the second quick-release portion 53, and the positioning column is inserted into the positioning hole, so that the cradle is positioned and mounted, and the cradle can be disassembled by pulling out the positioning column. Specifically, the positioning column can realize quick release through the following implementations.

In an implementation, at least two positioning columns are provided, a relative position relationship between the cradle 50 and the connecting member 40 is constrained by two-point positioning, and the cradle 50 can rotate with the rotation of the connecting member 40.

In an implementation, the positioning column is a prism or a frustum. For example, with reference to the embodiment of FIG. 3, the connecting member 40 integrally forms the positioning column, the positioning column is a quadrangular prism, a shape of the positioning hole corresponds to that of the positioning column, and the positioning column transmits a torque through the side surfaces, so that the cradle 50 can rotate with the rotation of the connecting member 40.

In an implementation, the positioning column is provided with an external thread, and the positioning column and the positioning hole realize quick release and torque transmission through the thread.

In an implementation, the positioning column and the positioning hole are in interference fit, and the positioning column and the positioning hole transmit the torque through friction. At the moment, at least one of the positioning column and the positioning hole is made of an elastic material, and the elastic material may be deformed, so as to facilitate pulling out the positioning column.

Certainly, the first quick-release portion 41 and the second quick-release portion 53 may also use other quick-release designs in the existing technology, and cooperative connection between the positioning column and the positioning hole are not limited to the above implementations.

In some embodiments, the shakable milk warmer comprises a rolling body 60, and the rolling body 60 is mounted between a bottom portion of the cradle 50 and a bottom portion of the water bath chamber. For example, with reference to FIG. 3, the rolling body 60 may be mounted on the cradle 50, and the rolling body 60 is implemented by a roll ball. The rolling body 60 can replace the cradle 50 to contact with the bottom portion of the water bath chamber, thus changing sliding friction into rolling friction, and making the cradle 50 rotate more smoothly. Moreover, a plurality of rolling bodies 60 can also play a positioning role to avoid the cradle 50 from shaking.

The shakable milk warmer comprises a shell 10. With reference to FIG. 1 and FIG. 4, in some embodiments, the shell 10 comprises a first wall 11, the first wall 11 forms a cavity with two open ends, the heating member 20 is mounted at one end of the cavity, and the first wall 11 and the heating member 20 are enclosed to form the water bath chamber. This design further improves detachability of the shakable milk warmer, which is convenient to wash the water bath chamber and maintain the heating member 20. Meanwhile, the heating member 20 heats from the bottom portion of the water bath chamber, which can promote up-down convection in the water bath chamber, and achieve more uniform water temperature distribution, thus being conductive to improving use experience of the shakable milk warmer.

Considering that the shakable milk warmer adopts water bath heating, the shakable milk warmer further comprises a first sealing member 70, and the first sealing member 70 is mounted between the first wall 11 and the heating member 20. The first sealing member 70 seals a gap between the first wall 11 and the heating member 20, thus reducing the risk of leakage.

Further, the shakable milk warmer further comprises a second sealing member 80, and the second sealing member 80 is mounted between the rotating shaft 30 and the bottom portion of the water bath chamber, thus reducing the risk of leakage.

The first sealing member 70 and the second sealing member 80 may be mounted in different ways. In some embodiments, the shakable milk warmer comprises a first fixing member 90, the first fixing member 90 is mounted on the shell 10, and the first fixing member 90 presses and fixes the heating member 20 on the first wall 11.

Specifically, with reference to FIG. 3 and FIG. 4, the shell 10 comprises a second wall 12, the second wall 12 is located at an outer side of the first wall 11, the second wall 12 is columnar, a plurality of second walls 12 are arranged around the first wall 11 (only one of the second walls 12 is shown in the figures), a screw hole is formed at an end portion of the second wall 12, and the first fixing member 90 is mounted on the second wall 12 by threaded connection. The first sealing member 70 is wrapped around an edge of the heating member 20, the first wall 11 forms a mounting step corresponding to the heating member 20, and the first fixing member 90 presses the first sealing member 70 on the mounting step. An avoidance hole is formed in a middle portion of the first fixing member 90, so as to avoid interference with the heating member 20. The first sealing member 70 may be made of a silica gel material which is resistant to high temperature and easy to clean.

In some embodiments, the shakable milk warmer further comprises a second fixing member 160, the second fixing member 160 is mounted on the first fixing member 90 or the heating member 20, the second fixing member 160 is provided with a mounting groove, the second sealing member 80 is arranged in the mounting groove, the second fixing member 160 presses the second sealing member 80 on the heating member 20, and the rotating shaft 30 extends through the second sealing member 80 and the second fixing member 160. The second sealing member 80 may be a standard rotating shaft sealing ring, such as an oil seal.

In some embodiments, the heating member 20 comprises a mounting tray 21 and a heating tube 22, the shakable milk warmer further comprises a temperature sensor 100 and a fuse 110, the heating tube 22, the temperature sensor 100 and the fuse 110 are mounted on the mounting tray 21, and the temperature sensor 100 and the fuse 110 are connected with the heating tube 22. Specifically, the mounting tray 21 may be made of a metal material with excellent thermal conductivity, such as a stainless steel material, and the heating tube 22 may be combined with the mounting tray 21 by brazing, thus improving the thermal conductivity between the heating tube 22 and the mounting tray 21. The temperature sensor 100 may be a thermistor, and based on a temperature monitored by the temperature sensor 100, the shakable milk warmer can perform feedback control on heating. The fuse 110 improves the use safety of the shakable milk warmer.

In some embodiments, the clamping portion comprises a plurality of elastic sheets 51 arranged on a side surface of the cradle 50 in a circumferential direction, and the elastic sheets 51 are configured for abutting against a side wall of a milk bottle to clamp the milk bottle.

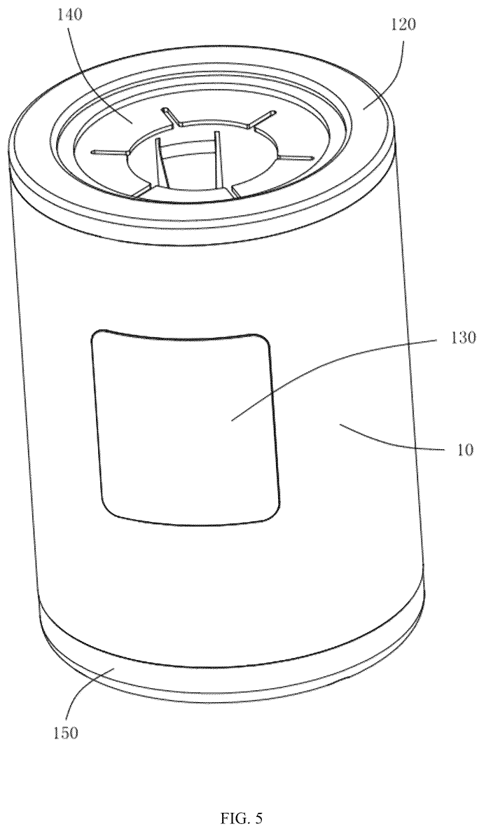

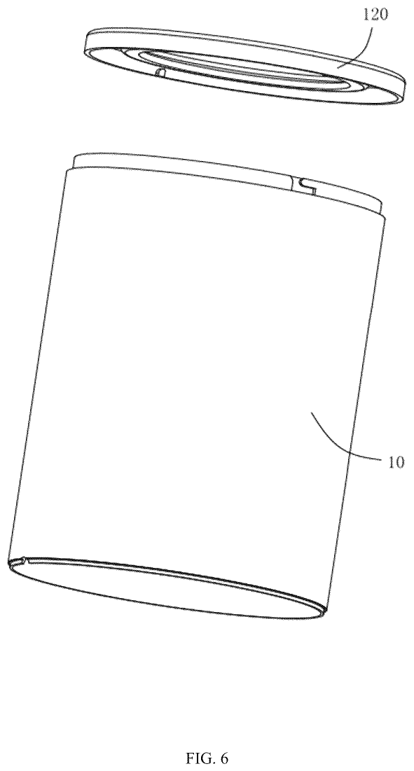

In some embodiments, with reference to FIG. 6, the shakable milk warmer comprises a top cover 120, the top cover 120 is detachably mounted on the shell 10, the top cover 120 is located at an opening of the water bath chamber, and the top cover 120 is configured for limiting the cradle 50. The top cover 120 can avoid taking out the cradle 50 when taking out the milk bottle. The top cover 120 may be detachably mounted through a buckle and a clamping groove. For example, in FIG. 6, the buckle is formed on an inner wall of the top cover 120, and the clamping groove corresponding to the buckle is formed in an outer periphery of the shell 10. With reference to FIG. 1 and FIG. 5, the shakable milk warmer further comprises a bottom cover 150, the bottom cover 150 is detachably mounted on the shell 10, and components inside the shell 10 may be conveniently cleaned or maintained after the top cover is disassembled.

In some embodiments, the shakable milk warmer comprises a protective sleeve 140, and the protective sleeve 140 is mounted at an entrance of the cradle 50. The protective sleeve 140 is made of silica gel or other elastic materials. With reference to FIG. 5, on one hand, the protective sleeve 140 is arranged between the cradle 50 and the top cover 120 to play a buffering role, and on the other hand, the protective sleeve 140 can also play a certain auxiliary positioning role, thus making the milk bottle more stable.

In some embodiments, with reference to FIG. 5, the shakable milk warmer further comprises a panel 130, the panel 130 is mounted on a side surface of the shell 10, and the panel 130 is configured for human-computer interaction and display.

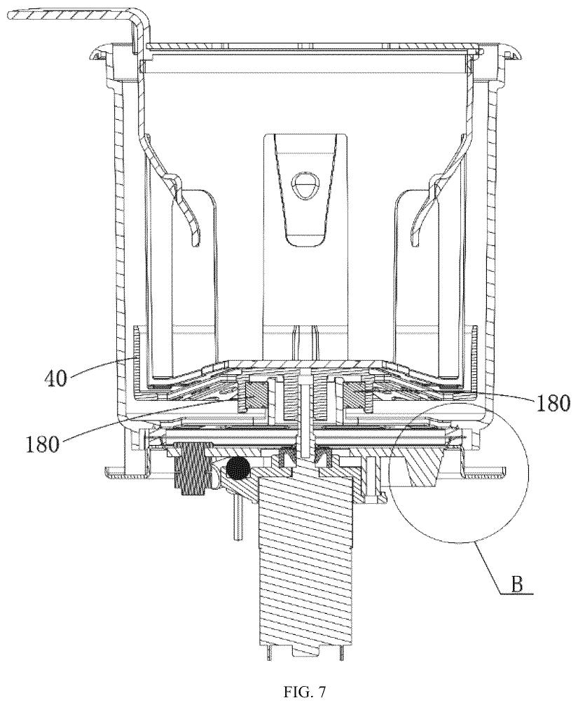

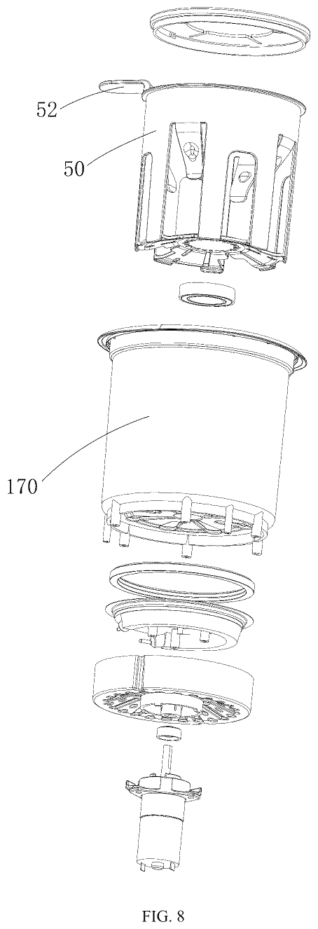

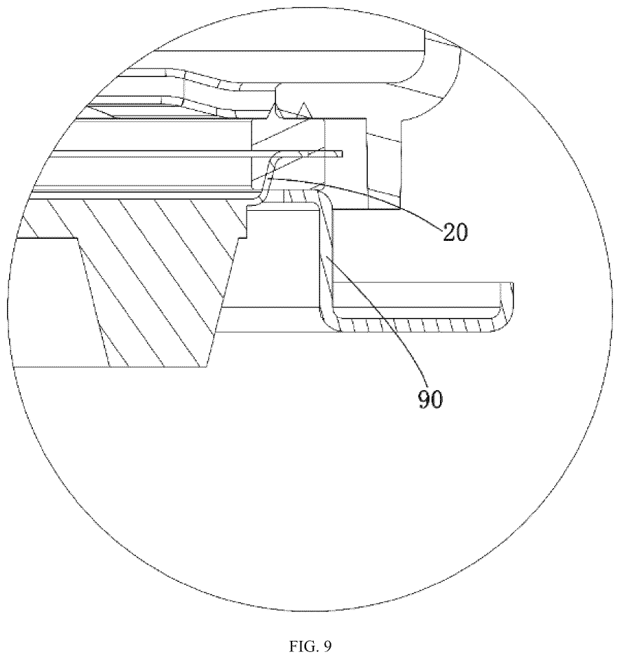

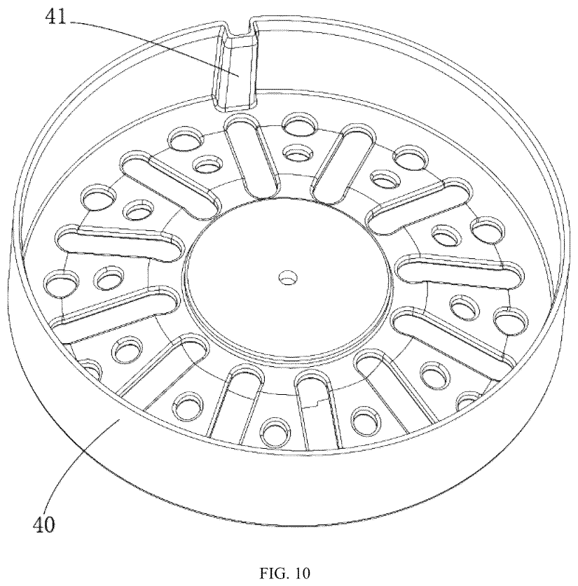

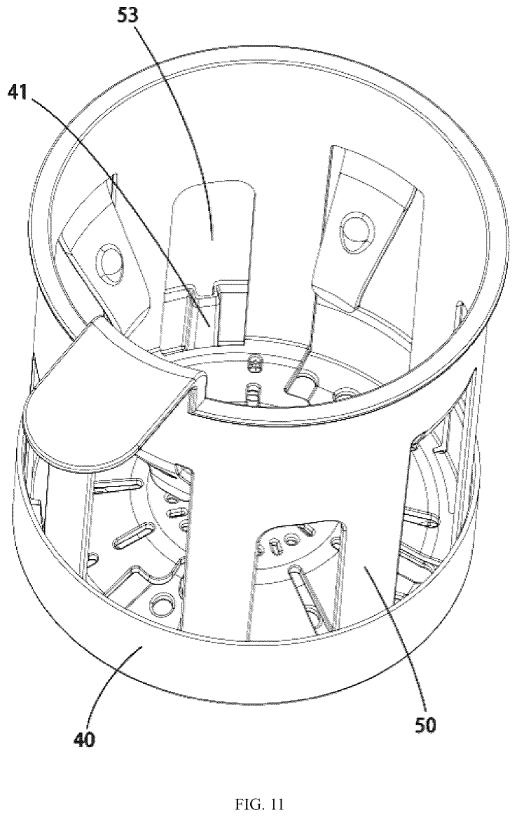

With reference to FIG. 7 to FIG. 11, Second Embodiment of the present disclosure provides a shakable milk warmer, a water bath chamber with an open end is formed in the shakable milk warmer, and the shakable milk warmer comprises a heating member 20, a rotating shaft 30, a connecting member 40, a cradle 50, a first quick-release portion 41 and a second quick-release portion 53. The heating member 20 is in heat transfer connection with an outer wall surface of the water bath chamber, and the water bath chamber is formed by enclosing a water tank 170 and the heating member 20. The rotating shaft 30 is rotatably arranged to extend through a bottom portion of the water bath chamber. The connecting member 40 is mounted at one end of the rotating shaft 30 located in the water bath chamber. The first quick-release portion 41 is a protrusion arranged on the connecting member. The second quick-release portion 53 is a groove arranged in the cradle. The cradle is detachably and limitedly mounted with the protrusion on the connecting member through the groove, the cradle 50 is configured for placing a milk bottle, the cradle 50 comprises a clamping portion, and the clamping portion is configured for fixing the milk bottle.

Further, a rotating member 180 is arranged between the water bath chamber and the connecting member 40, an outer ring of the rotating member 180 is in interference fit with the connecting member 40, an inner ring of the rotating member 180 is in interference fit with the water bath chamber, and the rotating member 180 may limit a horizontal movement of the connecting member 40, thus improving the stability of the connecting member 40 during rotation. Meanwhile, the above configuration also enables the rotating member 180 to be rotatably connected to the water bath chamber stably. After the machine is started, a motor drives the connecting member 40 to rotate, and the cradle 50 rotates along with the connecting member 40, so that the milk bottle in the cradle 50 is moderately shaken to realize uniform heating of the milk bottle while performing water bath heating on the milk bottle in the cradle 50.

As a further preferred example, the cradle 50 may be provided with a handle 52, and the cradle 50 is detachably and limitedly mounted on the connecting member 40, thus being convenient for a user to take out the cradle 50 for washing, maintenance or replacement.

In the descriptions of the specification, the descriptions with reference to the terms “an embodiment”, “some embodiments”, “illustrative embodiment”, “example”, “specific example” or “some examples”, etc., refer to that specific features, structures, materials, or characteristics described with reference to the embodiments or examples are included in at least one embodiment or example of the present disclosure. In the specification, the schematic representation of the above terms does not necessarily mean the same embodiment or example. Moreover, the specific features, structures, materials or characteristics described may be combined in any one or more embodiments or examples in a suitable manner.

Although the embodiments of the present disclosure have been shown and described, those of ordinary skills in the art should understand that: various changes, amendments, substitutions and modifications can be made to these embodiments without departing from the principles and purposes of the present disclosure, and the scope of the present disclosure is limited by the claims and equivalents thereof.

1. A shakable milk warmer, a water bath chamber with an open end being formed within the shakable milk warmer, and the shakable milk warmer comprising:
a heating member, wherein the heating member is in heat transfer connection with an outer wall surface of the water bath chamber;
a rotating shaft, wherein the rotating shaft is rotatably arranged to extend through a bottom portion of the water bath chamber;
a connecting member, wherein the connecting member is arranged at one end of the rotating shaft located in the water bath chamber; and
a cradle, wherein the cradle comprises: a clamping portion, the clamping portion comprises a plurality of elastic sheets arranged on an inner side wall of the cradle in a circumferential direction, and the elastic sheets are configured for abutting against an inner side wall of a milk bottle to clamp the milk bottle;
wherein the shakable milk warmer comprises a first quick-release portion and a second quick-release portion.

2. The shakable milk warmer according to claim 1, wherein the first quick-release portion is a protrusion arranged on the connecting member.

3. The shakable milk warmer according to claim 1, wherein the second quick-release portion is a groove arranged in the cradle, and the cradle is detachably and limitedly mounted with the first quick-release portion through the groove.

4. The shakable milk warmer according to claim 1, wherein the shakable milk warmer comprises a rotating member, an outer ring of the rotating member is in interference fit with the connecting member, an inner ring of the rotating member is in interference fit with an inner ring of the water bath chamber, and the rotating member is configured for horizontally limiting the connecting member and improving stability of the connecting member during rotation.

5. The shakable milk warmer according to claim 1, wherein the cradle comprises a handle, the handle is located at an opening of the cradle, and the handle is configured for taking and placing the cradle.

6. The shakable milk warmer according to claim 1, wherein the first quick-release portion and the second quick-release portion are cooperatively connected through a positioning column and a positioning hole, and the cooperative connection is realized by at least one of the following methods:
1) at least two positioning columns are provided;
2) a shape of the positioning column is a prism or a frustum;
3) the positioning column is provided with an external thread; or
4) the positioning column and/or the positioning hole is made of an elastic material, and the positioning column and the positioning hole are in interference fit with each other.

7. The shakable milk warmer according to claim 1, wherein the shakable milk warmer further comprises: a rolling body, and the rolling body is arranged between a bottom portion of the cradle and the bottom portion of the water bath chamber.

8. The shakable milk warmer according to claim 1, wherein the shakable milk warmer comprises a shell, the shell comprises a first wall, the first wall forms a cavity with two open ends, the heating member is mounted at one end of the cavity, the first wall and the heating member are enclosed to form the water bath chamber, the shakable milk warmer comprises a first sealing member, and the first sealing member is mounted between the first wall and the heating member.

9. The shakable milk warmer according to claim 8, wherein the shakable milk warmer comprises a second sealing member, and the second sealing member is mounted between the rotating shaft and the bottom portion of the water bath chamber.

10. The shakable milk warmer according to claim 9, wherein the shakable milk warmer comprises a first fixing member, the first fixing member is mounted on the shell, and the first fixing member presses and fixes the heating member on the first wall.

11. The shakable milk warmer according to claim 10, wherein the first sealing member is wrapped around an edge of the heating member, the first wall forms a mounting step corresponding to the heating member, the first fixing member presses the first sealing member on the mounting step, the shakable milk warmer comprises a second fixing member, the second fixing member is mounted on the first fixing member or the heating member, the second fixing member is provided with a mounting groove, the second sealing member is arranged in the mounting groove, the second fixing member presses the second sealing member on the heating member, and the rotating shaft extends through the second sealing member and the second fixing member.

12. The shakable milk warmer according to claim 8, wherein the heating member comprises a mounting tray and a heating tube, the shakable milk warmer further comprises a temperature sensor and a fuse, the heating tube, the temperature sensor and the fuse are mounted on the mounting tray, and the temperature sensor and the fuse are connected with the heating tube.

13. The shakable milk warmer according to claim 8, wherein the shakable milk warmer comprises a top cover, the top cover is detachably mounted on the shell, the top cover is located at an opening of the water bath chamber, and the top cover is configured for limiting the cradle.
